(19) United States
(12) Patent Application Publication
(10) Pub. No.: US 2016/0145168 A1
(43) Pub. Date: May 26, 2016

(54) Preparation method of nanosheet nitrogen-containing porous carbon material

(71) Applicants: NORTH UNIVERSITY OF CHINA, Taiyuan (CN); INSTITUTE OF COAL CHEMISTRY, CHINESE ACADEMY OF SCIENCES, Taiyuan (CN)

(72) Inventors: Tuoping Hu, Taiyuan (CN); Wenzhong Shen, Taiyuan (CN); Hongyan Song, Taiyuan (CN); Jinquan Wei, Taiyuan (CN); Wenxia Zhou, Taiyuan (CN); Weiguang Ping, Taiyuan (CN); Xi Chen, Taiyuan (CN)

(73) Assignees: NORTH UNIVERSITY OF CHINA; INSTITUTE OF COAL CHEMISTRY, CHINESE ACADEMY OF SCIENCES

(21) Appl. No.: 14/712,032

(22) Filed: May 14, 2015

(30) Foreign Application Priority Data
Nov. 21, 2014 (CN) 201410671744.6

(51) Int. Cl. C07B 43/00; C01B 31/02

(52) U.S. Cl. CPC C07B 43/00; C01B 31/0293

(57) ABSTRACT

A preparation method of a nanosheet nitrogen-containing porous carbon material includes steps of: dissolving alkali and water-soluble amine-containing compound in water, forming an aqueous solution; adding cellulose or a derivative thereof into the aqueous solution; after mixing and drying, obtaining a crystal composite of the alkali and the water-soluble amine-containing compound, wrapped by the cellulose or the derivative thereof; carbonizing the crystal composite under nitrogen gas flow; washing a crabonized product; and obtaining the nanosheet nitrogen-containing porous carbon material. Through changing a proportion among the alkali, the water-soluble amine-containing compound and the cellulose or the derivative thereof, a specific surface area, pore structure, nitrogen content and thickness of the nanosheet nitrogen-containing porous carbon material are adjusted. The nanosheet nitrogen-containing porous carbon material has the thickness of 10-100 nm, the specific surface area of 800-2000 m²/g, pore volume of 0.50-1.50 cm³/g, and the nitrogen content of 1-8 wt %.

### CROSS REFERENCE OF RELATED APPLICATION

The present invention claims priority under 35 U.S.C. 119(a-d) to CN 201410671744.6, filed Nov. 21, 2014.

### BACKGROUND OF THE PRESENT INVENTION

1. Field of Invention

The present invention relates to a preparation method of porous carbon material, and more particularly to a preparation method of nitrogen-containing porous carbon material. The porous carbon prepared by present invention is nanosheet-structured.

2. Description of Related Arts

A porous carbon has high specific surface area, large pore volume, uniform pore size distribution and good chemical thermal stability. The porous carbon material has broad application prospect in fields of adsorption, optical elements, nano-reactors, catalyzing, electrochemistry, supercapacitors and energy storage. A multi-scale structure of pore size effectively improves diffusion of guest molecules in pore channel of the porous carbon material. The large pore channel facilitates migration of macromolecules; and the small pore size provides required specific surface area and pore volume for the diffusion, showing high mass and energy transmission efficiency.

Porous carbon, which contains a nitrogen-containing functional group, has surface hydrophilicity because of existing nitrogen atoms therein. Particularly, because of basic functional group, absorption selectivity of the porous carbon material for polar molecules is effectively improved; and the basic functional group plays as catalytic active site of a Knoevenagel reaction. Thus, introducing the nitrogen-containing functional group onto the surface of the porous carbon material is able to improve the adsorption selectivity of the porous carbon material for the polar molecules. The nitrogen-containing functional group is traditionally introduced by ammonfication of the porous carbon material through feeding ammonia at high temperature, forming nitrogen-containing functional group on the surface of porous carbon material. However, the traditional introducing method is liable to change a structure of the pore channel of the porous carbon material, such as reducing the pore size and pore volume. Thus, researchers pay attention to synthesize nitrogen-containing porous carbon material using nitrogen-containing precursor. For example, through polymerizing nitrogen-containing monomers as precursors for preparing the porous carbon material or adopting nitrogen-containing polymer as precursors, the nitrogen-containing porous carbon material is prepared after carbonization and activation at high temperature.

On the whole, preparation and application of the nitrogen-containing porous carbon material are required to overcome two problems: how to solve controllability of a pore size distribution and an ordered combination of templates; and how to realize modification of surface chemical property of the porous carbon material. A synthesis of the nitrogen-containing multi-scale porous carbon material, intended to accomplish controllable pore size, decrease of cost and hydrophilic surface, requires new synthesis route and suitable raw materials.

The pore structure and surface chemical property of porous carbon material determine its application performance. Morphology of porous carbon material also plays an important role in its application performance For example, carbon nanotube containing iron shows good catalyzing and oxidation performance; cubic ordered mesoporous-structured carbon material, which is derived from carbide, has high hydrogen-storage capacity and ultrahigh electric capacity; porous carbon with core-shell structure has high density as energy storage material; and nanosheet-structured grapheme shows good charging and discharging performance.

### SUMMARY OF THE PRESENT INVENTION

In order to accomplish the above objects, the present invention provides a preparation method of nanosheet nitrogen-containing porous carbon material.

Principles of the present invention are described as follows. Nanosheet crystal of alkali and water-soluble amine-containing compound is formed, playing as a template of the nanosheet nitrogen-containing porous carbon material. During carbonization, the alkali as a catalyst facilitates forming pore channel; the water-soluble amine-containing compound is carbonized and decomposed, generating nitrogen-containing free radical combined with carbon matrix to form nitrogen-containing functional group.

The preparation method of nanosheet nitrogen-containing porous carbon material in present invention adopts cellulose or a derivative thereof as a raw material and forms a sheet-structured template through the self-assembly of the alkali and the water-soluble amine-containing compound when drying. After the carbonization, the nanosheet nitrogen-containing porous carbon material is obtained. The preparation method of nanosheet nitrogen-containing porous carbon material comprises steps of:

(1) dissolving an alkali and a water-soluble amine-containing compound in water, forming an aqueous solution; adding a cellulose or a derivative thereof into the aqueous solution; uniformly mixing and drying the aqueous solution; and obtaining a crystal composite of the alkali and the water-soluble amine-containing compound, which is wrapped by the cellulose or the derivative thereof;

(2) under nitrogen gas flow, carbonizing the crystal composite of the alkali and the water-soluble amine-containing compound, which is wrapped by the cellulose or the derivative thereof, at 600-900° C. for a time of 60-180 min, so as to obtain a carbonized product; and

(3) washing the carbonized product with water or dilute acid and obtaining the nanosheet nitrogen-containing porous carbon material.

The crystal composite of the alkali and the water-soluble amine-containing compound, which is wrapped by the cellulose or the derivative thereof, comprises: 30-89% (weight percentage) of the cellulose or the derivative thereof; 10-50% of the alkali; and 1-20% of the water-soluble amine-containing compound.

The alkali is alkali metal hydroxide or alkali metal oxide, which is able to form a sheet crystal, comprising lithium hydroxide, sodium hydroxide, potassium hydroxide, sodium oxide and potassium oxide.

Preferably, the water-soluble amine-containing compound is at least one member selected from a group consisting of urea, melamine, carbinolamine, cholamine, ethanediamine, triethanolamine and amino acid.

Preferably, the cellulose or the derivative thereof is cellulose, hemicellulose, amino cellulose or carboxyl cellulose.

Preferably, the step of drying the aqueous solution in the step (1) lasts 12-24 h under 80-100° C.

The present invention changes the proportion among alkali, water-soluble amine-containing compound and cellulose or the derivative thereof, so as to adjust specific surface area, pore structure, nitrogen content and thickness of the nanosheet nitrogen-containing porous carbon material. The nanosheet nitrogen-containing porous carbon material derived from the present invention has a thickness of 10-100 nm, specific surface area of 800-2000 m²/g, pore volume of 0.50-1.50 cm³/g, and nitrogen content of 1-8 wt %.

The present invention starts with precursor and template of the nitrogen-containing porous carbon material, and adjusts a structure, morphology and the nitrogen-containing functional group of the carbon material by controlling the self-assembly and the carbonization, so as to control the morphology and the structure of the pore channel of the nanosheet nitrogen-containing porous carbon material.

The preparation method of the present invention has following advantages. Firstly, the cellulose or the derivative thereof is able to disperse in the aqueous solution of alkali and water-soluble amine-containing compound; after drying, the cellulose or the derivative thereof is also able to uniformly wrap the crystal composite formed by alkali and water-soluble amine-containing compound. Secondly, through the self-assembly of alkali and water-soluble amine-containing compound during drying, the nanosheet crystal is formed and plays as the template of the nanosheet nitrogen-containing porous carbon material. Thirdly, the alkali induces the nitrogen-containing porous carbon material to be sheet-structured after drying; the alkali, as an activation agent, promotes forming pores during carbonization. Fourthly, the nanosheet nitrogen-containing porous carbon material prepared by the present invention has unique morphology and developed pore structure; the nanosheet nitrogen-containing porous carbon material, which has high specific surface area and pore volume, facilitates mass diffusion; and as adsorption material, the nanosheet nitrogen-containing porous carbon material has high adsorption amount and fast adsorption velocity and shows good adsorption performance for polar molecules.

These and other objectives, features, and advantages of the present invention will become apparent from the following detailed description, the accompanying drawings, and appended claims.

### BRIEF DESCRIPTION OF THE DRAWINGS

FIG. 1 is a 5,000 magnification scanning electron microscope (SEM) image of a nanosheet nitrogen-containing porous carbon material according to a fourth example of the present invention.

FIG. 2 is a 20,000 magnification SEM image of the nanosheet nitrogen-containing porous carbon material according to the fourth example of the present invention.

FIG. 3 is a 5,000 magnification SEM image of the nanosheet nitrogen-containing porous carbon material according to an eighteenth example of the present invention.

FIG. 4 is a 20,000 magnification SEM image of the nanosheet nitrogen-containing porous carbon material according to the eighteenth example of the present invention.

### DETAILED DESCRIPTION OF THE PREFERRED EMBODIMENT

### Examples 1-6

Potassium hydroxide and urea were dissolved in 100 ml of water, forming an aqueous solution, wherein dosages of the potassium hydroxide and the urea are showed in Table 1. Then cellulose was added and dispersed into the aqueous solution, wherein a dosage of the cellulose is showed in Table 1. Then the aqueous solution was uniformly mixed, dried at 80° C., and carbonized at 600° C., so as to obtain a carbonized product. The carbonized product was washed with water and then a nanosheet nitrogen-containing porous carbon material was obtained. Experimental conditions and performance testing results are shown in Table 1.

TABLE 1
preparation requirements and performance parameters of
nanosheet nitrogen-containing porous carbon material

| | | | | | | | Specific | |
|---|---|---|---|---|---|---|---|---|
| | | Potassium | | Time of | | Nitrogen | surface | Pore |
| | Cellulose | hydroxide | Urea | carbonizing | Thickness | content | area | volume |
| | (g) | (g) | (g) | (h) | (nm) | (wt %) | (m²/g) | (cm³/g) |
| Example 1 | 10 | 10 | 1 | 2 | 40-100 | 0.81 | 836 | 0.53 |
| Example 2 | 10 | 10 | 5 | 1 | 40-100 | 2.12 | 1213 | 0.65 |
| Example 3 | 10 | 10 | 10 | 1 | 40-100 | 4.76 | 995 | 0.56 |
| Example 4 | 20 | 20 | 5 | 3 | 20-80 | 1.89 | 1512 | 0.75 |
| Example 5 | 20 | 30 | 5 | 3 | 10-60 | 1.76 | 1684 | 0.88 |
| Example 6 | 30 | 50 | 5 | 1 | 10-20 | 1.14 | 2537 | 1.35 |

### Examples 7-12

Hydroxide or oxide and urea were dissolved in 100 ml of water, forming an aqueous solution, wherein dosages of the hydroxide or the oxide and the urea are showed in Table 2. Then cellulose was added and dispersed into the aqueous solution, wherein a dosage of the cellulose is showed in Table 2. Then the aqueous solution was uniformly mixed, dried at 80° C., and carbonized at 700° C., so as to obtain a carbonized product. The carbonized product was washed with water and then a nanosheet nitrogen-containing porous carbon material was obtained. Experimental conditions and performance testing results are shown in Table 2.

TABLE 2
preparation requirements and performance parameters of
nanosheet nitrogen-containing porous carbon material

| | | | | | | | Specific | |
|---|---|---|---|---|---|---|---|---|
| | | | | Time of | | Nitrogen | surface | Pore |
| | Cellulose | Alkali | Urea | carbonizing | Thickness | content | area | volume |
| | (g) | (g) | (g) | (h) | (nm) | (wt %) | (m²/g) | (cm³/g) |
| Example 7 | 10 | KOH, 10 | 1 | 1 | 10-60 | 0.61 | 1028 | 0.61 |
| Example 8 | 10 | LiOH, 5 | 5 | 2 | 10-60 | 2.01 | 1325 | 0.74 |
| Example 9 | 10 | NaOH, 10 | 10 | 2 | 10-60 | 3.76 | 1945 | 0.83 |
| Example 10 | 20 | K₂OH, 10 | 5 | 1 | 10-40 | 1.39 | 2212 | 0.95 |
| Example 11 | 20 | NA₂O, 20 | 5 | 2 | 10-30 | 1.16 | 2684 | 1.28 |
| Example 12 | 20 | K₂O, 20 | 5 | 2 | 10-20 | 0.94 | 2937 | 1.45 |

### Examples 13-18

Potassium hydroxide and water-soluble amine-containing compound were dissolved in 100 ml of water, forming an aqueous solution, wherein dosages of the potassium hydroxide and the water-soluble amine-containing compound are showed in Table 3. Then cellulose was added and dispersed into the aqueous solution, wherein a dosage of the cellulose is showed in Table 3. Then the aqueous solution was uniformly mixed, dried at 80° C., and carbonized at 800° C., so as to obtain a carbonized product. The carbonized product was washed with water and a nanosheet nitrogen-containing porous carbon material was obtained. Experimental conditions and performance testing results are shown in Table 3.

TABLE 3
preparation requirements and performance parameters of nanosheet nitrogen-containing porous carbon material

| | | | Amine- | | | | Specific | |
|---|---|---|---|---|---|---|---|---|
| | | Potassium | containing | Time of | | Nitrogen | surface | Pore |
| | Cellulose | hydroxide | compound | carbonizing | Thickness | content | area | volume |
| | (g) | (g) | (g) | (h) | (nm) | (wt %) | (m²/g) | (cm³/g) |
| Example 13 | 10 | 10 | Melamine, 1 | 1 | 10-60 | 0.81 | 1041 | 0.64 |
| Example 14 | 10 | 10 | Carbinolamine, 5 | 1 | 10-60 | 2.71 | 1311 | 0.80 |
| Example 15 | 10 | 10 | Ethanediamine, 10 | 1 | 10-60 | 4.35 | 1895 | 0.96 |
| Example 16 | 20 | 20 | Amino acid, 5 | 1 | 10-40 | 1.09 | 2188 | 1.15 |
| Example 17 | 20 | 30 | Triethanolamine, 5 | 2 | 10-30 | 1.18 | 2536 | 1.39 |
| Example 18 | 20 | 50 | Urea, 5 | 1 | 10-20 | 1.04 | 2873 | 1.50 |

### Examples 19-24

Potassium hydroxide and urea were dissolved in 100 ml of water, forming an aqueous solution, wherein dosages of the potassium hydroxide and the urea are showed in Table 4. Then cellulose was added and dispersed into the aqueous solution, wherein a dosage of the cellulose is showed in Table 4. Then the aqueous solution was uniformly mixed, dried at 80° C., and carbonized at 600° C., so as to obtain a carbonized product. The carbonized product was washed with water and a nanosheet nitrogen-containing porous carbon material was obtained. Experimental conditions and performance testing results are shown in Table 4.

TABLE 4
preparation requirements and performance parameters of
nanosheet nitrogen-containing porous carbon material

| | | | | | | | Specific | |
|---|---|---|---|---|---|---|---|---|
| | | Potassium | | Time of | | Nitrogen | surface | Pore |
| | Cellulose | hydroxide | urea | carbonizing | Thickness | content | area | volume |
| | (g) | (g) | (g) | (h) | (nm) | (wt %) | (m²/g) | (cm³/g) |
| Example 19 | Amino cellulose, 10 | 10 | 1 | 2 | 40-100 | 1.01 | 852 | 0.55 |
| Example 20 | Amino cellulose, 10 | 20 | 5 | 2 | 40-100 | 2.52 | 1482 | 0.69 |
| Example 21 | Carboxyl cellulose, 10 | 10 | 1 | 2 | 40-100 | 0.77 | 1005 | 0.61 |
| Example 22 | Carboxyl cellulose, 10 | 20 | 5 | 2 | 30-80 | 1.89 | 1493 | 0.78 |
| Example 23 | Hemicellulose, 10 | 10 | 1 | 2 | 20-60 | 0.76 | 1084 | 0.68 |
| Example 24 | Hemicellulose, 10 | 20 | 5 | 2 | 20-50 | 1.98 | 1537 | 0.95 |

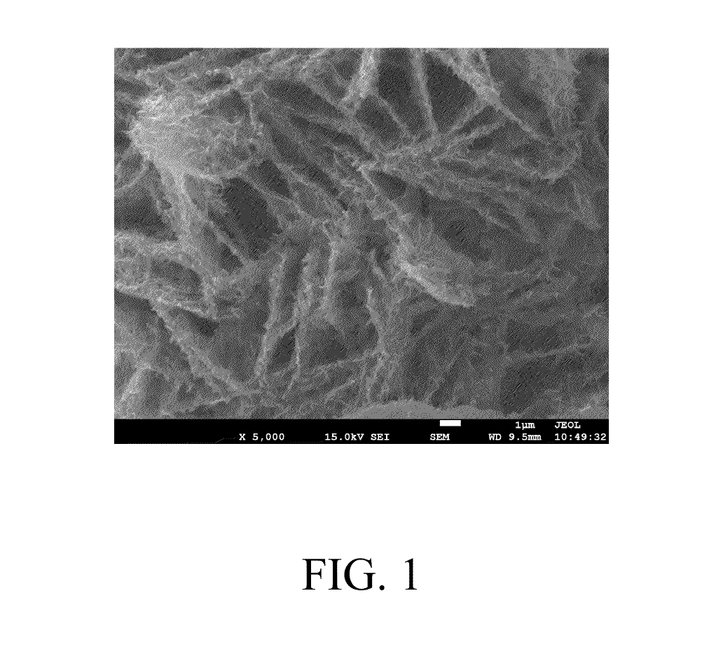

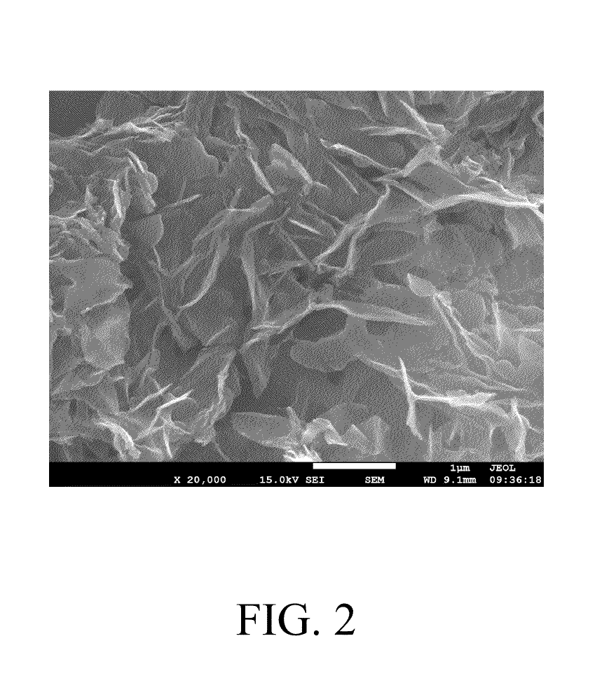

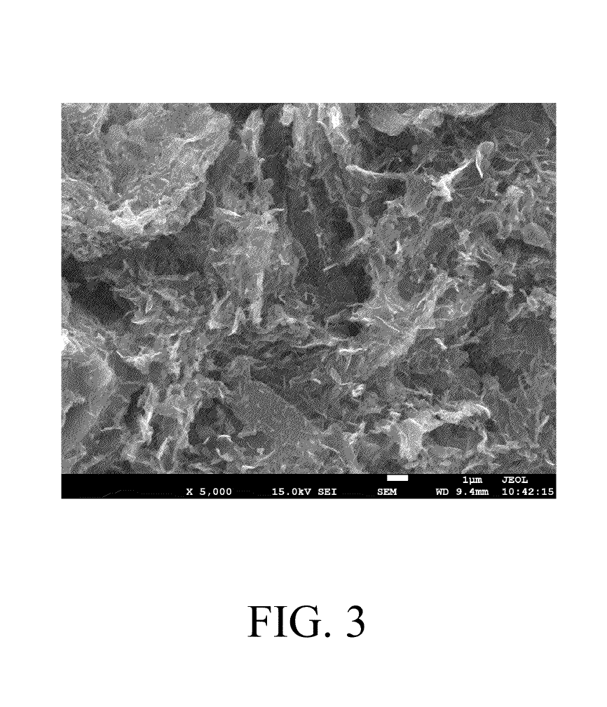

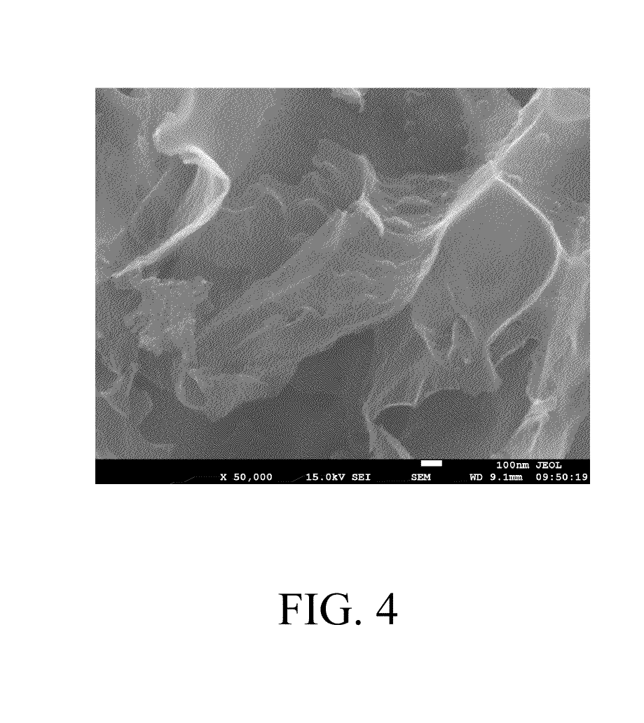

From above examples of present invention, the cellulose or derivative thereof is a carbon source; a crystal composite formed by self-assembly of alkali and water-soluble amine-containing compound plays as template; and after carbonization, the nanosheet nitrogen-containing porous carbon material with developed pore structure is obtained, wherein typical morphologies of the nanosheet nitrogen-containing porous carbon material are shown in FIG. 1-FIG. 4. The nitrogen-containing porous carbon material prepared by present invention has high specific surface area, large pore volume and contains nitrogen-containing functional group. Additionally, with increasing carbonization temperature, thickness and arrangement uniformity arrangement of nanosheets are decreased.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A preparation method of a nanosheet nitrogen-containing porous carbon material, wherein: a cellulose or a derivative thereof is adopted as a raw material; a sheet-structured template is formed through a self-assembly of a crystal composite of an alkali and a water-soluble amine-containing compound; and after carbonization, the nanosheet nitrogen-containing porous carbon material is obtained; comprising steps of:
(1) dissolving the alkali and the water-soluble amine-containing compound in water, forming an aqueous solution; adding the cellulose or the derivative thereof into the aqueous solution; uniformly mixing and drying the aqueous solution; and obtaining the crystal composite of the alkali and the water-soluble amine-containing compound, which is wrapped by the cellulose or the derivative thereof;
(2) under nitrogen gas flow, carbonizing the crystal composite of the alkali and the water-soluble amine-containing compound, which is wrapped by the cellulose or the derivative thereof, at 600-900° C. for 60-180 min, so as to obtain a carbonized product; and
(3) washing the carbonized product with water or dilute acid and obtaining the nanosheet nitrogen-containing porous carbon material.

2. The preparation method of the nanosheet nitrogen-containing porous carbon material, as recited in claim 1, wherein the crystal composite of the alkali and the water-soluble amine-containing compound, which is wrapped by the cellulose or the derivative thereof, comprises:
30-89% (weight percentage) of the cellulose or the derivative thereof
10-50% of the alkali; and
1-20% of the water-soluble amine-containing compound.

3. The preparation method of the nanosheet nitrogen-containing porous carbon material, as recited in claim 1, wherein the alkali is alkali metal hydroxide or alkali metal oxide, which is able to form a sheet crystal.

4. The preparation method of the nanosheet- nitrogen-containing porous carbon material, as recited in claim 3, wherein the alkali is lithium hydroxide, sodium hydroxide, potassium hydroxide, sodium oxide or potassium oxide.

5. The preparation method of the nanosheet nitrogen-containing porous carbon material, as recited in claim 1, wherein the water-soluble amine-containing compound is at least one member selected from a group consisting of urea, melamine, carbinolamine, cholamine, ethanediamine, triethanolamine and amino acid.

6. The preparation method of the nanosheet nitrogen-containing porous carbon material, as recited in claim 1, wherein the cellulose or the derivative thereof is cellulose, hemicellulose, amino cellulose or carboxyl cellulose.

7. The preparation method of the nanosheet nitrogen-containing porous carbon material, as recited in claim 1, wherein the step of drying the aqueous solution drying in the step (1) lasts 12-24 h at 80-100° C.
